(19) United States
(12) Patent Application Publication
(10) Pub. No.: US 2008/0207467 A1
(43) Pub. Date: Aug. 28, 2008

(54) Methods for the design of libraries of protein variants

(75) Inventors: Gregory L. Moore, Pasadena, CA (US); John R. Desjarlais, Pasadena, CA (US)

Correspondence Address: MORGAN, LEWIS & BOCKIUS, LLP, ONE MARKET SPEAR STREET TOWER, SAN FRANCISCO, CA, 94105, US

(73) Assignee: Xencor, Inc.

(21) Appl. No.: 11/517,719

(22) Filed: Sep. 7, 2006

Related U.S. Application Data
(63) Continuation-in-part of application No. 11/367,184, filed on Mar. 3, 2006.
(60) Provisional application No. 60/659,018, filed on Mar. 3, 2005.

(51) Int. Cl. C40B 50/00

(52) U.S. Cl. 506/23

(57) ABSTRACT

The present invention is directed to designing a collection of protein variants.

The present application is a continuation-in-part of U.S. patent application Ser. No. 11/367,184, filed Mar. 3, 2006, which claims benefit to U.S. Provisional Application No. 60/659,018 filed Mar. 3, 2005, each of which is incorporated herein by reference in its entirety.

### FIELD OF THE INVENTION

The invention relates to the design of libraries of protein variants.

### BACKGROUND OF THE INVENTION

Protein engineering often involves the design and synthesis of a variant pool of protein variants that contain amino acid sequences that differ from the wild-type protein by one or more amino acid substitutions. Several methods have been suggested previously for designing libraries of protein variants, including alanine scanning, site-directed mutagenesis, saturation mutagenesis, random mutagenesis, and the use of a specific set of nine mutations (U.S. Patent Appl. No. 2005/0136428; Rajpal et al. PNAS 2005, 102(24): 8466-71, incorporated entirely by reference). These methods are flawed in that they generate protein libraries that are either too big or too small.

Alanine scanning is a method in which only an alanine substitution is used at a given position. An alanine substitution is much more likely to knockout or disrupt existing protein function than to gain or improve it. In this case, the protein library is too small because of the lack of high-quality substitutions.

Site-directed mutagenesis is a method in which a very small number (typically one) of amino acids are used at a given position. Again, protein libraries with one or two members are likely to be too small because of our lack of complete understanding of the protein sequence/structure/function relationship. Somewhat larger site-directed protein libraries can be designed from the most conservative substitutions determined from calculations based on protein structure (e.g., PDA®: U.S. Pat. No. 6,188,965; U.S. Pat. No. 6,269,312; U.S. Pat. No. 6,403,312; U.S. Pat. No. 6,708,120; U.S. Pat. No. 6,792,356; U.S. Pat. No. 6,801,861; U.S. Pat. No. 6,804,611; U.S. Ser. No. 09/782,004; U.S. Ser. No. 09/927,790; U.S. Ser. No. 10/218,102; PCT WO 98/07254; PCT WO 01/40091; PCT WO 02/25588; and Dahiyat & Mayo 1996, Protein Sci. 5: 895, all incorporated entirely by reference) or information condensed from a multiple sequence alignment (e.g., substitution matrices such as BLOSUM: Henikoff & Henikoff 1992, PNAS 89: 10915-10919, incorporated entirely by reference). However, these libraries are still likely to be too small in that they suffer from the “putting all one's eggs in one basket” flaw, where too many of the suggested amino acid substitutions are redundant with each other in terms of their biophysical properties (e.g., {I, L, V} all are hydrophobic and moderately sized).

Saturation mutagenesis (in which typically all or almost all 20 natural amino acids are used) and random mutagenesis (in which any of the natural 20 amino acids may be randomly used) are two methods in which a large number of substitutions may be tried at a given position. In these cases, generated libraries are too large since they often contain (i) too many redundant members (similar biophysical properties) and (ii) too many low-quality members.

Recently, the first of these two flaws has been addressed by the use of a specific set of nine mutations at a specific position (U.S. Patent Appl. No. 2005/0136428; Rajpal et al. PNAS 2005, 102(24): 8466-71, incorporated entirely by reference). Rajpal et al. suggest the use of a library of {A, S, H, L, P, Y, D, Q, K} at each position regardless of the context of the design. This library improves upon the use of saturation mutagenesis in that it largely eliminates redundant substitutions while retaining a set in which each member is fairly unique in terms of its biophysical properties. Still, it is unlikely that each of these nine substitutions is a high-quality one. For instance, if the position of interest is buried, it is unlikely that charged {D, K} and polar {S, H, Y, Q} substitutions are compatible with the protein structure. In addition, it is unclear how to adjust this library in response to a need for (i) fewer or greater members and/or (ii) specific compositional constraints such as the inclusion or exclusion of a given set of amino acids. Therefore, although the use of this set of nine is a step forward, a number of challenges still remain.

Thus, a need remains for a systematic method to design libraries of protein variants that are high-quality without containing redundant substitutions while still remaining subject to compositional constraints.

### SUMMARY OF THE INVENTION

The present invention is directed to designing a collection of protein variants. In one aspect, the present invention is directed to a method of designing a collection of protein variants. A parent protein sequences is provided. P variable amino acid positions are identified in the parent protein sequence, wherein P is two or more. A positional alphabet of mᵢ amino acids is provided for each of the variable position. A variant pool size n is chosen, where the summation of mᵢ amino acids for all of the variable positions is greater than n. A suitability score is calculated for a plurality of subsets L of all possible sets of n variant proteins, wherein calculating the suitability score comprises: i) a fitness score of each subset L and ii) a coverage score calculated by applying a dissimilarity matrix to each subset L. The subset L having the highest suitability score from the plurality of subsets is selected.

### BRIEF DESCRIPTION OF THE DRAWINGS

FIG. 1. A flowchart describing the variant pool optimization scheme.

FIG. 2. (a) The topological amino acid dissimilarity matrix generated in Example 1. (b) The alternate topological amino acid dissimilarity matrix generated in Example 1.

FIG. 3. (a) The hydrophobicity physico-chemical vector used in Example 2. (b) The hydrophobicity amino acid dissimilarity matrix generated in Example 2.

FIG. 4. (a) The charge physico-chemical vector used in Example 3. (b) The charge amino acid dissimilarity matrix generated in Example 3.

FIG. 5. The combined topological/hydrophobicity/charge amino acid dissimilarity matrix generated in Example 4 after scaling by its maximum value.

FIG. 6. The combined topological/hydrophobicity/charge amino acid dissimilarity matrix generated in Example 5.

FIG. 7. Optimal variant pool members (fitness index α=0) for variant pool sizes of 1 to 10 amino acids. Note that C and M are excluded from consideration as variant pool members.

FIG. 8. Optimal additions (fitness index α=0) to preexisting variant pools (column 2) to reach the specified sizes (column 1). Note that C and M are excluded from consideration as variant pool members.

FIG. 9. Optimal deletions (fitness index α=0) to preexisting variant pools (column 2) to reach the specified sizes (column 1). Note that C and M are excluded from consideration as variant pool members.

FIG. 10. Percentile grading (fitness index α=0) of preexisting variant pools. Note that C and M are excluded from consideration as variant pool members.

FIG. 11. Optimal variant pools (fitness index α=0) from adding to the wild-type amino acid (column 1) for the specified variant pool sizes (column 2). Note that C and M are excluded from consideration as variant pool members.

FIG. 12. (a) Amino acid fitnesses calculated from the dissimilarity of the wild-type amino acid. (b) Sets of eight optimal variant pools for fitness indices α=(1, 6/7, 5/7, . . . , 0). In each row, the left-most variant pool is most focused around the wild-type amino-acid (α=1) and the right-most library has the highest coverage (α=0). Note that C and M are excluded from consideration as variant pool members.

FIG. 13. (a) Amino acid sequences of the light and heavy chains of an anti-VEGF antibody before affinity maturation (Protein Data Bank code 1BJ1) (SEQ ID NOS:1-2). Sequence positions with amino acids within 5 Angstroms of the antigen/antibody interface (underlined and boldfaced) are selected for variant pool design. (b) Variant pool design of the selected sequence positions. Each sequence position (denoted by Kabat numbering as well as the wild-type amino acid) has three variant pools designed for it corresponding to fitness indices α=0.0, 0.5, and 1.0. Also listed for each library are the coverage and fitness z-scores. (c) The three variant pools designed for VL 94V compressed onto a 2-D coordinate system. Variant pool members are circled, and the wild-type V is underlined. Crossed-out amino acids were excluded from consideration. (d) Alternate variant pool design of the selected sequence positions. These results differ from those presented in part (b) of this figure due to compositional constraints; namely, these variant pools were constrained to contain (i) the most conservative substitution as determined from the dissimilarity matrix, (ii) at least one negatively charged amino acid {D or E}, and (iii) at least one positively charged amino acid {R or K}.

FIG. 14. (a) Optimal five- and nine-member variant pools for a given wild-type amino acid (α=0.5).

FIG. 15. Multiple positional variant pool design of the selected light and heavy chain sequence positions (see FIG. X). The set of sequence positions (denoted by Kabat numbering as well as the wild-type amino acid) has three variant pools designed for it corresponding to total sizes of 30, 60, and 96 amino acid substitutions (not including wild-type amino acids).

### DESCRIPTION OF THE INVENTION

As discussed herein, the invention is directed to a method of designing protein variants. By “protein” as used herein is meant at least two amino acids linked together by a peptide bond. As used herein, protein includes proteins, oligopeptides, polypeptides and peptides. The peptidyl group may comprise naturally occurring amino acids and peptide bonds, or synthetic peptidomimetic structures, i.e. “analogs”, such as peptoids (see Simon et al., PNAS USA 89(20):9367 (1992)). The amino acids may either be naturally occurring or non-naturally occurring. The side chains may be in either the (R) or the (S) configuration. In a preferred embodiment, the amino acids are in the (S) or L-configuration.

This invention focuses specifically on variant pools of amino acid substitutions for a single sequence position in a protein. For instance, given a wild-type amino acid of V at a specific position in a protein, some possible variant pools of substitutions include {A, I, L, S, T} and {A, E, F, K, N}. These two variant pools illustrate two important properties of variant pools considered in the invention, namely fitness and coverage.

The first set, {A, I, L, S, T}, is a set of amino acids that have very similar biophysical properties to the wild-type V. In particular, {A, I, L} have similar hydrophobicity while {S, T } have similar size. Since these substitutions are fairly conservative and less likely to disrupt the tertiary structure of the protein, they can be said to have high fitness. Here the term fitness is defined as a quantification of the expectation that an amino acid will produce the desired design goal. Although in this example the fitness of a substitution was assumed to be analogous with its conservativeness, this assumption may vary depending on the particular design situation. Other methods for predicting amino acid fitness may include those that are based on protein structure(s) or sequence(s) or some combination thereof. This may include substitution matrices, dissimilarity matrices, similarity matrices, PDA® technology, ACE™ technology, multiple sequence alignments, and even extrapolation from earlier experimental results.

In contrast to the first set, the second set, {A, E, F, K, N}, is a set of amino acids that have very different biophysical properties from the wild-type V. This set differs from the first in that its members cover a wide range of amino acid properties, which can be considered to be the placement of different experimental hypotheses. Each of its amino acids has very distinct biophysical properties when compared to the others in the set: A, small; E, negatively charged; F, hydrophobic; K, positively charged; N, polar neutral. This set can be said to have high coverage, where the term coverage is here defined as a quantification of the ability of the variant pool to represent amino acids of interest based upon one or more criteria of amino acid dissimilarity. Some biophysical properties that may be included in the quantification of coverage include charge, hydrophobicity, size, topology, and hydrogen-bonding patterns.

The two sets used to illustrate the definitions of fitness and coverage have opposing natures—the first is high fitness, low coverage while the second is low fitness, high coverage. Neither of these sets (e.g. libraries) constitutes a well-designed experiment. The first set includes a number of redundant amino acid hypotheses while the second does not include enough high-quality hypotheses. These types of sets can often result from design methods that consider fitness while neglecting coverage or vice versa. In this invention, a systematic methodology for the design of libraries of variants with a high suitability score (e.g., high-coverage as well as high-fitness) is developed.

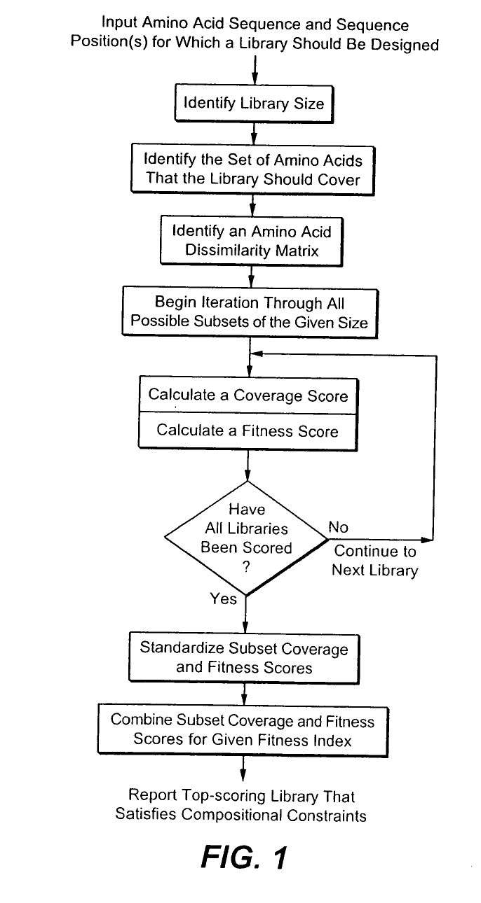

Given a specific sequence position in a parent protein, the invention provides a variant pool, a set of amino acids to be substituted The parent protein may be a naturally occurring protein or a protein variant relative to another protein. Output of the method may include replacement amino acids with a high level of coverage of a specified amino acid group, replacement amino acids with many high-fitness amino acids, or replacement amino acids with high levels of both coverage and fitness. Note that the single-position libraries that result from the invention can be combined to form serial, point-mutation scanning libraries (i.e., {A, E, F, K, N} at position X and {A, I, L, S, T} at position Y: 10 total single-mutation protein variants) or combinatorial libraries (i.e., {A, E, F, K, N} at position X and {A, I, L, S, T} at position Y: 25 total double-mutation protein variants, 10 total single-mutation variants). The optimization scheme is depicted in FIG. 1 and is described in detail below.

Step 1. Identify the size of the variant pool to be designed. Variant pool “size” n refers to the number of proteins in the variant pool; for example, a variant pool of a protein substituted at a single position with {E, F, K, T, A} has size 5 and is said to have 5 members. The size of the variant pool may depend on a number of predetermined criteria such as predicted importance of the position to the design goal, proximity to a binding site/interface/active site, or even practical concerns such as the availability of experimental resources and capacity.

Step 2. Identify the pluralities of amino acids that the variant pool is being designed to cover. This plurality is termed the “positional alphabet”, or “alphabet”, and is represented by m. Possible positional alphabets include, but are not limited to, all twenty natural amino acids {A, C, D, E, F, G, H, I, K, L, M, N, P, Q, R, S, T, V, W, Y}; all natural amino acids excluding cysteine, methionine, proline, and tryptophan {A, D, E, F, G, H, I, K, L, N, Q, R, S, T, V, Y}; polar amino acids {D, E, H, K, N, Q, R, S, T, Y}; and hydrophobic amino acids {A, F, I, L, P, V, W}. Other possible positional alphabets may include unnatural amino acids such as para-acetyl-phenylalanine. Positional alphabets may also be composed of amino acid groups such as {aliphatic, aromatic, small, polar}. In preferred embodiments, the positional alphabet of interest is all natural amino acids excluding cysteine, methionine, proline, and tryptophan. In certain embodiments, the same positional alphabet is used at multiple positions. In other embodiments, different positional alphabets are used at different positions.

Step 3. Identify an amino acid dissimilarity matrix that describes the lack of similarity between pairs of amino acids. This allows the later quantification of how well library members cover alphabet amino acids. Examples of dissimilarity matrices include, but are not limited to, matrices based on physico-chemical descriptors (e.g., hydrophobicity, volume, charge, hydrogen-bonding patterning), matrices based on topological differences, and matrices based on substitution matrices such as BLOSUM (Henikoff & Henikoff 1992, PNAS 89: 10915-10919, incorporated entirely by reference) and PAM (Dayhoff et al. 1978, in “Atlas of Protein Sequence and Structure” Dayhoff (ed.) 5(3): 345-352, incorporated entirely by reference). Other matrices that may serve as the basis for a dissimilarity matrix can be found, for example, in the AAIndex online database of amino acid matrices.

In preferred embodiments, the invention includes, but is not limited to, an amino acid dissimilarity matrix determined using a number of physico-chemical descriptors (e.g., hydrophobicity, charge, hydrogen bonding capability). For each of the physico-chemical descriptors, an amino acid dissimilarity matrix may be determined using Equation 1.

dis₍ₙ₎(a,b)=|prop₍ₙ₎(a)−prop₍ₙ₎(b)|

In Equation 1, a and b are amino acids, prop₍ₙ₎(a) is the nth physico-chemical value (e.g., hydrophobicity) of amino acid a and dis₍ₙ₎(a, b) is the nth dissimilarity between amino acids a and b as determined from their nth physico-chemical values.

In preferred embodiments, the invention includes, but is not limited to, an amino acid dissimilarity matrix describing the topological differences between amino acids in terms of the number of non-hydrogen side-chain atoms that must be added or removed to transform one amino acid into another (see Equation 2). In alternate embodiments, the invention includes, but is not limited to, an amino acid dissimilarity matrix describing the topological differences between amino acids in terms of the number of bonds that must be broken or formed to transform one amino acid into another.

$${dis}_{( topo )} ( a , b ) = \frac{\# of side \text{-} chain non \text{-} H atoms that be added \text{/} removed}{{max}_{a , b} ( \# of side \text{-} chain non \text{-} H atoms ) + 1} \qquad 2$$

In Equation 2, dis₍ₜₒₚₒ₎(a, b) is the topological dissimilarity between amino acids a and b.

In alternative embodiments, the invention includes, but is not limited to, an amino acid dissimilarity matrix determined using a substitution-scoring matrix (e.g., BLOSUM62). One way that substitution scores may be transformed into dissimilarity is presented in Equation 3.

$${dis}_{( sub )} ( a , b ) = \frac{S ( a , a ) + S ( b , b )}{2} - \frac{S ( a , b ) + S ( b , a )}{2} \qquad 3$$

In Equation 3, S(a, b) is the substitution score for the substitution of a for b and dis_{(sub)}(a, b) is the substitution-score-based dissimilarity between a and b.

In alternative embodiments, the invention includes, but is not limited to, an amino acid dissimilarity matrix determined from multiple sequence alignment data.

In preferred embodiments, the invention includes, but is not limited to, the weighted combination of multiple amino acid dissimilarity matrices as in Equation 4.

$$\begin{matrix}dis ( a , b ) = {w}_{( 1 )} \cdot {dis}_{( 1 )} ( a , b ) + {w}_{( 2 )} \cdot {dis}_{( 2 )} ( a , b ) + … + {w}_{( N )} \cdot \\ {dis}_{( N )} ( a , b ) \\ = {\sum }_{n = 1}^{N} {w}_{( n )} \cdot {dis}_{( n )} ( a , b )\end{matrix} \qquad 4$$

In Equation 4, w₍ₙ₎ is the relative weight of dissimilarity matrix n and N is the total number of dissimilarity matrices to be combined.

In alternative embodiments, the invention includes, but is not limited to, a final dissimilarity matrix scaling so that the maximum dissimilarity in the matrix is equal to 1, as shown in Equation 5.

$$dis ( a , b ) = dis ( a , b ) / {max}_{a , b} ( dis ( a , b ) ) \qquad 5$$

Step 4. Iterate through all possible subsets of amino acids with the desired variant pool size for the given positional alphabet. For each subset, calculate a coverage score (see Step 4.1) and a fitness score (see Step 4.2). Typically, the number of subsets to be scored is much less than 10⁶. For example, given a 20 amino acid positional alphabet to be covered, there are only (20 choose 8) or ₂₀C₈=125,970 possible 8-member subsets. In the following equations, L represents the subset that is being evaluated in the current iteration.

Step 4.1. Calculate a coverage score for each subset L for the positional alphabet A. Typically, this calculation is performed in three steps (see Steps 4.1a, 4.1b, and 4.1c).

Step 4.1a. Determine how well each subset member l ε L represents each of the positional alphabet amino acids a ε m. The degree of representation of amino acid a by subset member l is represented by ssMemberRep(a,l,L).

In preferred embodiments, k-means clustering methodology (Equation 6) is used to determine the degree of representation of amino acid a by subset member l in conjunction with the dissimilarity matrix from Step 3.

$$ssMemberRep ( a , l , L ) = \{ \begin{matrix}1 , & if subset member m is the most similar to amino acid a \\ 0 , & otherwise\end{matrix} \qquad 6$$

In other preferred embodiments, fuzzy c-means clustering methodology (Equation 7) is used to determine the degree of representation of a by subset member l in conjunction with the dissimilarity matrix from Step 3. Typically, the fuzziness coefficient z is set to 2.

$$ssMemberRep ( a , l , L ) = \{ \begin{matrix}1 , & if a = l \\ \frac{{( 1 / dis ( a , l ) )}^{2 / z - 1}}{{\sum }_{mm ∈ L} {( 1 / dis ( a , ll ) )}^{2 / z - 1}} , & if a is not a subset member \\ 0 , & otherwise\end{matrix} \qquad 7$$

Step 4.1b. Determine how well subset L as a whole represents each of the alphabet amino acids a ε m. The degree of representation of amino acid a by subset L is represented by subsetRep(a,L).

In preferred embodiments, the degree of representation of amino acid a by subset L is determined using Equation 8. The use of Equation 8 implies that smaller values of subsetRep(a,L) indicate stronger representation.

$$subsetRep ( a , L ) = {\sum }_{m ∈ L} ssMemberRep ( a , m , L ) \cdot dis ( a , l ) \qquad 8$$

In alternative embodiments, a Boolean descriptor of representation of amino acid a by subset L is used. If the nearest subset member to amino acid a is within a specified dissimilarity threshold, then a is represented by the subset (see Equation 9). The use of Equation 9 implies that larger values of subsetRep(a,L) indicate stronger representation.

$$subsetRep ( a , L ) = \{ \begin{matrix}1 , & if the dissimilarity of the most similar member \leq threshold \\ 0 , & otherwise\end{matrix} \qquad 9$$

Step 4.1c. Determine how well subset L covers the given alphabet A. The degree of coverage of alphabet A by subset L is represented by coverage(A,L). In preferred embodiments, this is done by a simple summation over the alphabet amino acids (Equation 10).

$$coverage ( A , L ) = {\sum }_{a ∈ A} subsetRep ( a , L ) \qquad 10$$

Step 4.2. Calculate a fitness score for each subset L. The fitness of subset L is represented by fitness(L) and the fitness of subset member m is represented by memberFitness(m). Larger values of subset fitness indicate that a subset contains more amino acids likely to fulfill the desired design goal.

In preferred embodiments, the invention includes, but is not limited to, scoring of subset fitness using Equation 11.

$$fitness ( L ) = {\sum }_{m ∈ L} memberFitness ( m ) \qquad 11$$

In alternate embodiments, a variety of functions and scaling factors may be used to determine subset fitness. By way of example, functions may include arithmetic means and/or geometric means.

The fitness of a subset member m may be predicted in a number of ways, including, but not limited to, substitution matrices, dissimilarity matrices, PDA® technology, ACE™ technology, multiple sequence alignments, and partial experimental results. In preferred embodiments, the fitness of a subset member/is given by its score in a substitution matrix as in Equation 12.

memberFitness(m)=S(l,wt) 12

In Equation 12, wt is the wild-type amino acid at the position for which the variant pool is being designed.

In other preferred embodiments, subset member fitness values are derived from dissimilarities to the wild-type amino acid at the position for which the variant pool is being designed (Equation 13).

memberFitness(m)=exp(−dis(l,wt)/T) 13

In Equation 13, wt is the wild-type amino acid at the position for which the variant pool is being designed and T is an appropriate temperature value.

In other preferred embodiments, subset member fitness values are derived from PDA® energies as shown in Equation 14.

memberFitness(l)=exp(−E^{PDA}(l)/T) 14

In Equation 14, E^{PDA}(l) is the energy of subset member m as determined from PDA® technology and T is an appropriate temperature value.

In other preferred embodiments, subset member fitness values are derived from ACE™ technology amino acid precedence values from a multiple sequence alignment (Equation 15).

memberFitness(l)=exp(−precedence(l)/T) 15

In Equation 15, precedence(m) is derived from an ACE™ technology analysis of a multiple sequence alignment and T is an appropriate temperature value.

In alternative embodiments, subset member fitness values are derived from amino acid frequencies from a multiple sequence alignment (Equation 16).

memberFitness(l)=freq(l) 16

In Equation 16, freq(l) is the frequency of subset member m derived from the multiple sequence alignment.

In alternative embodiments, subset member fitness values are derived from partial experimental results using Equations 17 and 18.

$$exper ( l ) = {\sum }_{b}^{results} exper ( b ) \cdot A \cdot exp ( - dis ( l , b ) \text{/} TT ) , for all l ∉ \{ results \} \qquad 17$$

memberFitness(l)=exp(−exper(l)/T) 18

In Equations 17 and 18, exper(l) is the inferred experimental result for subset member m, {results} is the set of amino acids for which experimental results are available, A is an appropriate normalization constant, and T, TT are appropriate temperature values.

In alternate embodiments, a variety of functions and scaling factors may be used to determine subset member fitness.

Step 5. Standardize the coverage and fitness scores for each subset L. In preferred embodiments, coverage scores and fitness scores are converted to z-scores that describe the number of standard deviations above or below the mean each score is. In other preferred embodiments, coverage scores and fitness scores are converted to percentiles that describe the rank of each score.

Step 6. Calculate an suitability score by combining the coverage and fitness scores for each subset L. The relative contributions of coverage and fitness to the suitability score are specified by the fitness index α, which describes the trade-off between the two scores. The fitness index ranges from zero to one (0≦α≦1), with zero being a complete emphasis on coverage and one being a complete emphasis on fitness. In a preferred embodiment, an suitability score is calculated using a combination of the coverage z-score and fitness z-score as in Equation 19.

suitabilityscore(L)=(1−α)(coverage zScore(L))+(α)(fitness zScore(L)) 19

In other preferred embodiments, an suitability score is calculated using a combination of the coverage percentile and fitness percentile as in Equation 20.

suitabilityscore(L)=(1−α)(coverage percentile(L))+(α)(fitness percentile(L)) 20

In alternative embodiments, an suitability score is calculated using a combination of the coverage and fitness with no standardization as in Equation 21.

suitabilityscore(L)=(1−α)(coverage(L))+(α)(fitness(L)) 21

Step 7. Select the designed variant pool from the subsets of amino acids for which suitability scores were determined. Typically, the highest scoring amino acid subset is selected as the designed library. In addition to the iterative enumeration of possible subsets outlined above, other optimization algorithms known in the art such as Monte Carlo, dynamic programming, simulated annealing, integer programming, genetic algorithm, and branch-and-bound may be used to search for the subset with the top suitability score. Compositional constraints may be applied to eliminate subsets from consideration. Examples of compositional constraints include, but are not limited to, subsets containing the wild-type amino acid; subsets excluding the wild-type amino acid; subsets containing a specified number of the most conservative substitutions as determined from a substitution matrix, dissimilarity matrix, multiple sequence alignment, etc.; subsets containing histidine (or other desired amino acid(s)); subsets containing at least one neutral amino acid, one positively charged amino acid, and one negatively charged amino acid; subsets excluding charged amino acids; and subsets including only amino acids that are a single nucleotide change apart.

Another aspect of the invention is to consider multiple positional variant pools of amino acid substitutions for a set of sequence positions in a protein(s). This leads to the following alterations being made to the stepwise procedure outlined above.

Step 1. Identify the total size of the multiple positional variant pools to be designed. In this case, the variant pool “total size” refers to the summation of the number of amino acids in each of the positional variant pools. The sizes of the positional variant pools are not required to be identified. For instance, given a set of 15 sequence positions, one may want to design a set of 15 positional variant pools containing 96 amino acid substitutions without specifying the individual sizes of the 15 positional variant pools.

Step 6. A suitability score is calculated by combining the coverage and fitness scores of each positional variant pool. In a preferred embodiment, the suitability score is calculated as in Equation X.

$$suitability score ( L ) = {\sum }_{i} ( 1 - α ) ( \frac{coverage ( {L}_{i} )}{{m}_{i} \cdot P} ) + ( α ) ( \frac{fitness ( {L}_{i} )}{n} ) \qquad 22$$

In Equation 22, i is the number of variable amino acid positions being considered, m is the size of the alphabet at position i, P is the number of variable amino acid positions being considered, and n is the total size of the multiple positional variant pools to be designed.

Making the Variant Proteins

Chemical Synthesis of Proteins

In a preferred embodiment, protein variants may be chemically synthesized. This is particularly useful when the variant proteins are short (e.g. less than 150 amino acids in length, less than 100 amino acids in length, or less than 50 amino acids in length) although as is known in the art, longer proteins may be made chemically or enzymatically. In one embodiment, amino acid sequences can be joined together via chemical ligation to form larger proteins as needed (see Yan, L. and Dawson, P. E, J. Am. Chem. Soc. 123 (2001) 526-533, and Dawson, P. E. and Kent, S. B. H, Ann. Rev. Biochem. 69, (2000) 923-960), hereby expressly incorporated by reference. Alternatively, proteins can be constructed by chemically synthesis of peptides and formed by ligation of the peptides using intein technology (Evans et al. (1999) J. Biol. Chem. 274, 18359-18363; Evans et al. (1999) J. Biol. Chem. 274, 3923-3926; Mathys et al. (1999) Gene 231, 1-13; Evans et al. (1998) Protein Sci. 7, 2256-2264; Southworth et al. Biotechniques 27, 110-120).

Generating Nucleic Acids that Encode Variant Proteins

In another embodiment, a variant protein sequence are used to create nucleic acids such as DNA which encode the sequence and which may then be cloned into host cells, expressed and assayed, if desired. Thus, nucleic acids, and particularly DNA, may be made which encodes each the protein sequence. This can be done using well-known procedures. See Maniatis and current protocols. (see Current Protocols in Molecular Biology, Wiley & Sons, and Molecular Cloning—A Laboratory Manual—3^{rd} Ed., Cold Spring Harbor Laboratory Press, New York (2001)). The choice of codons, suitable expression vectors and suitable host cells will vary depending on a number of factors, and may be easily optimized as needed.

Gene Assembly Procedures

The creation of variant proteins may be performed by several other methods, including, but not limited to, classical site-directed mutagenesis, e.g. Quickchange commercially available from Stratagene, cassette mutagenesis as well as other amplification techniques. Cassette mutagenesis could include the creation of DNA molecules from restriction digestion fragments using nucleic acid ligation, and includes the random ligation of restriction fragments (see Kikuchi et al., (1999), Gene 236, 159-167). Additionally, cassette mutagenesis could also be achieved using randomly-cleaved nucleic acids (see Kikuchi et al., (1999), Gene 236, 133-137), by PCR-ligation PCR mutagenesis (see for example Ali & Steinkasserer (1995), Biotechniques 18, 746-750), by seamless gene engineering using RNA- and DNA-overhang cloning (see Roc & Doc; Coljee et al., (2000) Nature Biotechnology 18, 789-791), by ligation mediated gene construction (U.S. Ser. No. 60/311,545), by homologous or non-homologous random recombination (see U.S. Pat. No. 6,368,861; U.S. Pat. No. 6,423,542; U.S. Pat. No. 6,376,246; U.S. Pat. No. 6,368,861; U.S. Pat. No. 6,319,714; WO0042561A3; WO0042561A2; WO0042560A3; WO0042560A2; WO0042559A1; WO0018906C2; WO0018906A3; and WO0018906A2), or in vivo using recombination between flanking sequences (see WO 02/10183 A1 and Abécassis et al., (2000) Nucleic Acids Research 28, e88 for examples). In addition, regions of the gene could be mutated in E. coli lacking correct mismatch repair mechanisms, (e.g. E. coli XLmutS strain commercially available from Stratagene), or by using phage display techniques to evolve a library (e.g. Long-McGie et al., (2000), Biotechnol Bioeng 68, 121-125).

In addition to the PCR methods outlined herein, there are other amplification and gene synthesis methods that can be used. For example, the genes may be “stitched” together using pools of oligonucleotides with polymerases (and optionally or solely) ligases. These resulting variable sequences can then be amplified using any number of amplification techniques, including, but not limited to, polymerase chain reaction (PCR), strand displacement amplification (SDA), nucleic acid sequence based amplification (NASBA), ligation chain reaction (LCR) and transcription mediated amplification (TMA). In addition, there are a number of variations of PCR which may also find use in the invention, including “quantitative competitive PCR” or “QC-PCR”, “arbitrarily primed PCR” or “AP-PCR” “immuno-PCR”, “Alu-PCR”, “PCR single strand conformational polymorphism” or “PCR-SSCP”, “reverse transcriptase PCR” or “RT-PCR”, “biotin capture PCR”, “vectorette PCR”. “panhandle PCR”, and “PCR select cDNA subtration”, among others. Furthermore, by incorporating the T7 polymerase initiator into one or more oligonucleotides, IVT amplification can be done.

Gene assembly procedures, including use of pooled oligonucleotides, PCR with pooled oligonucleotides, random codon generation, error prone PCR, modification of variant proteins to generate further variant proteins, and multiple mutations per oligonucleotides can also be prepared as described, for example, in U.S. patent application Ser. No. 10/218,102, incorporated herein by reference in its entirety.

Expression Systems

The variant proteins of the present invention can be produced by culturing a host cell transformed with nucleic acid, preferably an expression vector, containing nucleic acid encoding a variant protein, under the appropriate conditions to induce or cause expression of the variant protein. The conditions appropriate for variant protein expression will vary with the choice of the expression vector and the host cell, and will be easily ascertained by one skilled in the art through routine experimentation. For example, the use of constitutive promoters in the expression vector will require optimizing the growth and proliferation of the host cell, while the use of an inducible promoter requires the appropriate growth conditions for induction. In addition, in some embodiments, the timing of the harvest is important. For example, the baculoviral systems used in insect cell expression are lytic viruses, and thus harvest time selection can be crucial for product yield.

As will be appreciated by those in the art, the type of cells used can vary widely. The lists that follow are applicable both to the source of scaffold proteins as well as to host cells in which to produce the variant proteins. A wide variety of appropriate host cells can be used, including yeast, bacteria, archaebacteria, fungi, and insect, plant and animal cells, including mammalian cells. Of particular interest are Drosophila melanogaster cells, Saccharomyces cerevisiae and other yeasts, E. coli, Bacillus subtilis, Streptococcus cremoris, Streptococcus lividans, pED (commercially available from Novagen), pBAD and pCNDA (commercially available from Invitrogen), pEGEX (commercially available from Amersham Biosciences), pQE (commercially available from Qiagen), SF9 cells, C129 cells, 293 cells, Neurospora, BHK, CHO, COS, and HeLa cells, fibroblasts, Schwanoma cell lines, immortalized mammalian myeloid and lymphoid cell lines, Jurkat cells, mast cells and other endocrine and exocrine cells, and neuronal cells. See the ATCC cell line catalog, hereby expressly incorporated by reference. In one embodiment, the cells may be genetically engineered, that is, contain exogenous nucleic acid, for example, to contain target molecules.

In certain embodiments, a variant protein is expressed in a mammalian expression system, including systems in which the expression constructs are introduced into the mammalian cells using virus such as retrovirus or adenovirus. Any mammalian cells may be used, with mouse, rat, primate and human cells being particularly preferred, although as will be appreciated by those in the art, modifications of the system by pseudotyping allows all eukaryotic cells to be used, preferably higher eukaryotes. Accordingly, suitable mammalian cell types include, but are not limited to, tumor cells of all types (particularly melanoma, myeloid leukemia, carcinomas of the lung, breast, ovaries, colon, kidney, prostate, pancreas and testes), cardiomyocytes, endothelial cells, epithelial cells, lymphocytes (T-cells and B cells), mast cells, eosinophils, vascular intimal cells, hepatocytes, leukocytes including mononuclear leukocytes, stem cells such as haemopoetic, neural, skin, lung, kidney, liver and myocyte stem cells (for use in screening for differentiation and de-differentiation factors), osteoclasts, chondrocytes and other connective tissue cells, keratinocytes, melanocytes, liver cells, kidney cells, and adipocytes. Suitable cells also include known research cells, including, but not limited to, Jurkat T cells, NIH3T3 cells, CHO, COS, etc.

In another embodiment, a variant proteins is expressed in bacterial systems, including bacteria in which the expression constructs are introduced into the bacteria using phage. Bacterial expression systems are well known in the art, and include Bacillus subtilis, E. coli, Streptococcus cremoris, and Streptococcus lividans

Alternatively, a variant proteins can be produced in insect cells, including but not limited to Drosophila melanogaster S2 cells, as well as cells derived from members of the order Lepidoptera which includes all butterflies and moths, such as the silkmoth Bombyx mori and the alphalpha looper Autographa californica. Lepidopteran insects are host organisms for some members of a family of virus, known as baculoviruses (more than 400 known species), that infect a variety of arthropods. (see U.S. Pat. No. 6,090,584).

In a further embodiment, a variant protein is produced in insect cells. A nucleic acid encoding the variant protein can be transfected into SF9 Spodoptera frugiperda insect cells to generate baculovirus which are used to infect SF21 or High Five commercially available from Invitrogen, insect cells for high level protein production. Also, transfections into the Drosophila Schneider S2 cells will express proteins.

In another embodiment, the variant protein is produced in yeast cells. Yeast expression systems are well known in the art, and include expression vectors for Saccharomyces cerevisiae, Candida albicans and C. maltosa, Hansenula polymorpha, Kluyveromyces fragilis and K. lactis, Pichia guillerimondii and P. pastoris, Schizosaccharomyces pombe, and Yarrowia lipolytica.

Alternatively, a variant protein can be expressed in vitro using cell free translation systems. Several commercial sources are available for this including but not limited to Roche Rapid Translation System, Promega TnT system, Novagen's EcoPro system, Ambion's ProteinScipt-Pro system. In vitro translation systems derived from both prokaryotic (e.g. E. coli) and eukaryotic (e.g. Wheat germ, Rabbit reticulocytes) cells are available and can be chosen based on the expression levels and functional properties of the protein of interest. Both linear (as derived from a PCR amplification) and circular (as in plasmid) DNA molecules are suitable for such expression as long as they contain the gene encoding the protein operably linked to an appropriate promoter. Other features of the molecule that are important for optimal expression in either the bacterial or eukaryotic cells (including the ribosome binding site etc) are also included in these constructs. The proteins can again be expressed individually, or multiple proteins can be expressed in suitable size pools. The main advantage offered by these in vitro systems is their speed and ability to produce soluble proteins. In addition the protein can be selectively labeled if needed for subsequent functional analysis.

Transformation and Transfection Methods

The methods of introducing exogenous nucleic acid into host cells is well known in the art, and will vary with the host cell used. Techniques include dextran-mediated transfection, calcium phosphate precipitation, calcium chloride treatment, polybrene mediated transfection, protoplast fusion, electroporation, viral or phage infection, encapsulation of the polynucleotide(s) in liposomes, and direct microinjection of the DNA into nuclei. In the case of mammalian cells, transfection may be either transient or stable.

Expression Vectors

A variety of expression vectors may be utilized to express the variant proteins. The expression vectors are constructed to be compatible with the host cell type. Expression vectors may comprise self-replicating extrachromosomal vectors or vectors which integrate into a host genome. Expression vectors typically comprise a nucleic acid encoding a protein, any fusion constructs, control or regulatory sequences, selectable markers, and/or additional elements.

Preferred bacterial expression vectors include but are not limited to pET, pBAD, bluescript, pUC, pQE, pGEX, pMAL, and the like.

Preferred yeast expression vectors include pPICZ, pPIC3.5K, and pHIL-SI commercially available from Invitrogen.

Expression vectors for the transformation of insect cells, and in particular, baculovirus-based expression vectors, are well known in the art and are described e.g., in O'Reilly et al., Baculovirus Expression Vectors: A Laboratory Manual (New York: Oxford University Press, 1994).

A preferred mammalian expression vector system is a retroviral vector system such as is generally described in Mann et al., Cell, 33:153-9 (1993); Pear et al., Proc. Natl. Acad. Sci. U.S.A., 90(18):8392-6 (1993); Kitamura et al., Proc. Natl. Acad. Sci. U.S.A., 92:9146-50 (1995); Kinsella et al., Human Gene Therapy, 7:1405-13; Hofmann et al., Proc. Natl. Acad. Sci. U.S.A., 93:5185-90; Choate et al., Human Gene Therapy, 7:2247 (1996); PCT/US97/01019 and PCT/US97/01048, and references cited therein, all of which are hereby expressly incorporated by reference.

Inclusion of Control or Regulatory Sequences

Generally, expression vectors include transcriptional and translational regulatory nucleic acid sequences which are operably linked to the nucleic acid sequence encoding the variant protein.

The transcriptional and translational regulatory nucleic acid sequences are appropriate to the host cell used to express the variant protein, as will be appreciated by those in the art. For example, transcriptional and translational regulatory sequences from E. coli are preferably used to express proteins in E. coli.

Transcriptional and translational regulatory sequences may include, but are not limited to, promoter sequences, ribosomal binding sites, transcriptional start and stop sequences, translational start and stop sequences, and enhancer or activator sequences. In certain embodiments, the regulatory sequences include a promoter and transcriptional and translational start and stop sequences.

A suitable promoter is any nucleic acid sequence capable of binding RNA polymerase and initiating the downstream (3′) transcription of the coding sequence of variant protein into mRNA. Promoter sequences may be constitutive or inducible. The promoters may be naturally occurring promoters, hybrid or synthetic promoters.

A suitable bacterial promoter has a transcription initiation region which is usually placed proximal to the 5′ end of the coding sequence. The transcription initiation region typically includes an RNA polymerase binding site and a transcription initiation site. In E. coli, the ribosome-binding site is called the Shine-Dalgarno (SD) sequence and includes an initiation codon and a sequence 3-9 nucleotides in length located 3-11 nucleotides upstream of the initiation codon. Promoter sequences for metabolic pathway enzymes are commonly utilized. Examples include promoter sequences derived from sugar metabolizing enzymes, such as galactose, lactose and maltose, and sequences derived from biosynthetic enzymes such as tryptophan. Promoters from bacteriophage, such as the T7 promoter, may also be used. In addition, synthetic promoters and hybrid promoters are also useful; for example, the tac promoter is a hybrid of the trp and lac promoter sequences.

Preferred yeast promoter sequences include the inducible GAL1,10 promoter, the promoters from alcohol dehydrogenase, enolase, glucokinase, glucose-6-phosphate isomerase, glyceraldehyde-3-phosphate-dehydrogenase, hexokinase, phosphofructokinase, 3-phosphoglycerate mutase, pyruvate kinase, and the acid phosphatase gene.

A suitable mammalian promoter will have a transcription initiating region, which is usually placed proximal to the 5′ end of the coding sequence, and a TATA box, usually located 25-30 base pairs upstream of the transcription initiation site. The TATA box is thought to direct RNA polymerase II to begin RNA synthesis at the correct site. A mammalian promoter will also contain an upstream promoter element (enhancer element), typically located within 100 to 200 base pairs upstream of the TATA box. Typically, transcription termination and polyadenylation sequences recognized by mammalian cells are regulatory regions located 3′ to the translation stop codon and thus, together with the promoter elements, flank the coding sequence. The 3′ terminus of the mature mRNA is formed by site-specific post-translational cleavage and polyadenylation. Examples of transcription terminator and polyadenylation signals include those derived from SV40. An upstream promoter element determines the rate at which transcription is initiated and can act in either orientation. Of particular use as mammalian promoters are the promoters from mammalian viral genes, since the viral genes are often highly expressed and have a broad host range. Examples include the SV40 early promoter, mouse mammary tumor virus LTR promoter, adenovirus major late promoter, herpes simplex virus promoter, and the CMV promoter.

Inclusion of a Selectable Marker

In addition, in a preferred embodiment, the expression vector contains a selection gene or marker to allow the selection of transformed host cells containing the expression vector. Selection genes are well known in the art and will vary with the host cell used.

For example, a bacterial expression vector may include a selectable marker gene to allow for the selection of bacterial strains that have been transformed. Suitable selection genes include genes which render the bacteria resistant to drugs such as ampicillin, chloramphenicol, erythromycin, kanamycin, neomycin and tetracycline.

Yeast selectable markers include the biosynthetic genes ADE2, HIS4, LEU2, and TRP1 when used in the context of auxotrophe strains; ALG7, which confers resistance to tunicamycin; the neomycin phosphotransferase gene, which confers resistance to G418; and the CUP1 gene, which allows yeast to grow in the presence of copper ions.

Suitable mammalian selection markers include, but are not limited to, those that confer resistance to neomycin (or its analog G418), blasticidin S, histinidol D, bleomycin, puromycin, hygromycin B, and other drugs. Selectable markers conferring survivability in a specific media include, but are not limited to Blasticidin S Deaminase, Neomycin phophotranserase II, Hygromycin B phosphotranserase, Puromycin N-acetyl transferase, Bleomycin resistance protein (or Zeocin resistance protein, Phleomycin resistance protein, or phleomycin/zeocin binding protein), hypoxanthine guanosine phosphoribosyl transferase (HPRT), Thymidylate synthase, xanthine-guanine phosphoridosyl transferase, and the like.

Inclusion of Additional Elements

In addition, the expression vector may comprise additional elements. In certain embodiments, the vector contains a fusion protein, as discussed below. In other embodiments, the expression vector may have two replication systems, thus allowing it to be maintained in two organisms, for example in mammalian or insect cells for expression and in a prokaryotic host for cloning and amplification. Furthermore, for integrating expression vectors, the expression vector contains at least one sequence homologous to the host cell genome, and preferably two homologous sequences which flank the expression construct. The integrating vector may be directed to a specific locus in the host cell by selecting the appropriate homologous sequence for inclusion in the vector. Such vectors may include cre-lox recombination sites, or attR, attB, attP, and attL sites. Constructs for integrating vectors and appropriate selection and screening protocols are well known in the art and are described in e.g., Mansour et al., Cell, 51:503 (1988) and Murray, Gene Transfer and Expression Protocols, Methods in Molecular Biology, Vol. 7 (Clifton: Humana Press, 1991). In a preferred embodiment, the expression vector contains a RNA splicing sequence upstream or downstream of the gene to be expressed in order to increase the level of gene expression. (See Barret et al., Nucleic Acids Res. 1991; Groos et al., Mol. Cell. Biol. 1987; and Budiman et al., Mol. Cell. Biol. 1988.)

Fusion Constructs

The variant protein may also be made as a fusion protein, using techniques well known in the art. For example, fusion partners such as targeting sequences can be used which allow the localization of the variant protein into a subcellular or extracellular compartment of the cell. Purification tags may be fused with a variant protein, allowing its purification or isolation. Rescue sequences can be used to enable the recovery of the nucleic acids encoding them. Other fusion sequences are possible, such as fusions which enable utilization of a screening or selection technology.

Targeting or Signal Sequences

The expression vector may also include a signal peptide sequence that directs a variant protein and any associated fusions to a desired cellular location or to the extracellular media. Suitable targeting sequences include, but are not limited to, binding sequences capable of causing binding of the expression product to a predetermined molecule or class of molecules while retaining bioactivity of the expression product, (for example by using enzyme inhibitor or substrate sequences to target a class of relevant enzymes); sequences signalling selective degradation, of itself or co-bound proteins; and signal sequences capable of constitutively localizing the candidate expression products to a predetermined cellular locale, including a) subcellular locations such as the Golgi, endoplasmic reticulum, nucleus, nucleoli, nuclear membrane, mitochondria, chloroplast, secretory vesicles, lysosome, and cellular membrane; and b) extracellular locations via a secretory signal. Target sequences also may be used in conjunction with cell surface display technology as discussed below.

In other embodiments, the variant protein can be localized to either subcellular locations or to the outside of the cell via secretion. For example some targeting sequences enable secretion of variant proteins in bacteria. The signal sequence typically encodes a signal peptide comprised of hydrophobic amino acids which direct the secretion of the protein from the cell, as is well known in the art. This method may be useful for gram-positive bacteria or gram-negative bacteria. The protein can be either secreted into the growth media or into the periplasmic space, located between the inner and outer membrane of the cell.

Purification Tags

In certain embodiments, a variant protein comprises a purification tag operably linked to the rest of the protein. A purification tag is a sequence which may be used to purify or isolate the candidate agent, for detection, for immunoprecipitation, for FACS (fluorescence-activated cell sorting), or for other reasons. Thus, for example, purification tags include purification sequences such as polyhistidine, including but not limited to His₆, or other tag for use with Immobilized Metal Affinity Chromatography (IMAC) systems (e.g. Ni⁺² affinity columns), GST fusions, MBP fusions, Strep-tag, the BSP biotinylation target sequence of the bacterial enzyme BirA, and epitope tags which are targeted by antibodies. Suitable epitope tags include but are not limited to c-myc (for use with the commercially available 9E10 antibody), flag tag, and the like.

Labels

In one embodiment, the nucleic acids, proteins and antibodies used herein are labeled. In general, labels fall into three classes: a) immune labels, which may be an epitope incorporated as a fusion constructs may which is recognized by an antibody as discussed above, isotopic labels, which may be radioactive or heavy isotopes, and c) small molecule labels which may include fluorescent and calorimetric dyes or molecules such as biotin which enable the use of other labeling techniques. Labels may be incorporated into the compound at any position and may be incorporated in vivo during protein or peptide expression or in vitro.

Protein Purification

In another embodiment, the variant protein is purified or isolated after expression. Variant proteins may be isolated or purified in a variety of ways known to those skilled in the art depending on what other components are present in the sample. The degree of purification necessary will vary depending on the use of the variant protein. In some instances no purification will be necessary. For example in one embodiment, if variant proteins are secreted, screening or selection can take place directly from the media.

Standard purification methods include electrophoretic, molecular, immunological and chromatographic techniques, including ion exchange, hydrophobic, affinity, size exclusion chromatography, and reversed-phase HPLC chromatography, as well as precipitation, dialysis, and chromatofocusing techniques. Purification can often be facilitated by the inclusion of purification tag, as described above. For example, the variant protein may be purified using glutathione resin if a GST fusion is employed, Immobilized Metal Affinity Chromatography (IMAC) if a H is or other tag is employed, or immobilized anti-flag antibody if a flag tag is used. Ultrafiltration and diafiltration techniques, in conjunction with protein concentration, are also useful. For general guidance in suitable purification techniques, (see Scopes, R., Protein Purification: Principles and Practice 3^{rd} Ed., Springer-Verlag, NY (1994).), hereby expressly incorporated by reference.

### EXAMPLES

The following examples are illustrative of aspects of the inventions described herein.

### Example 1

### Generation of a Topological Amino Acid Dissimilarity Matrix

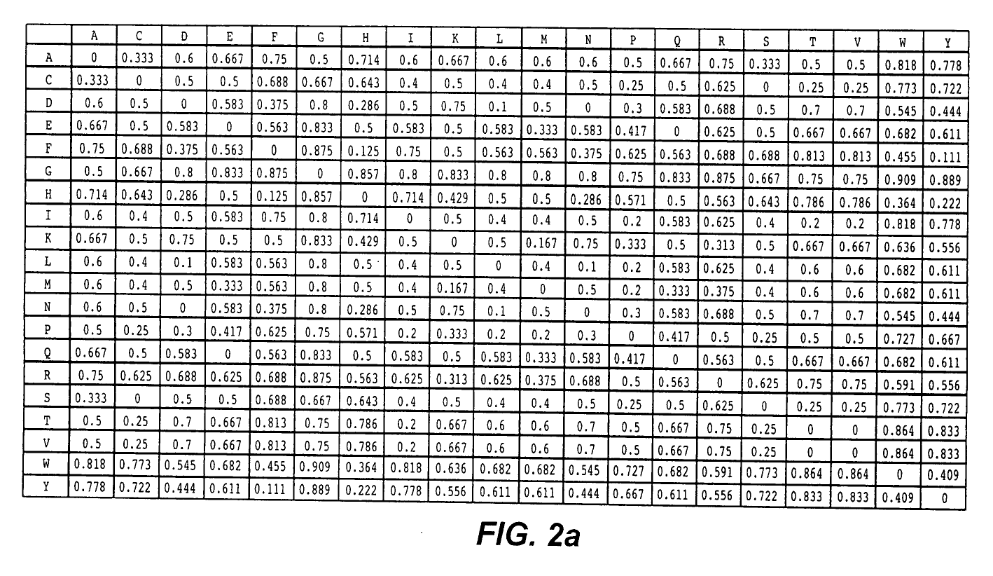

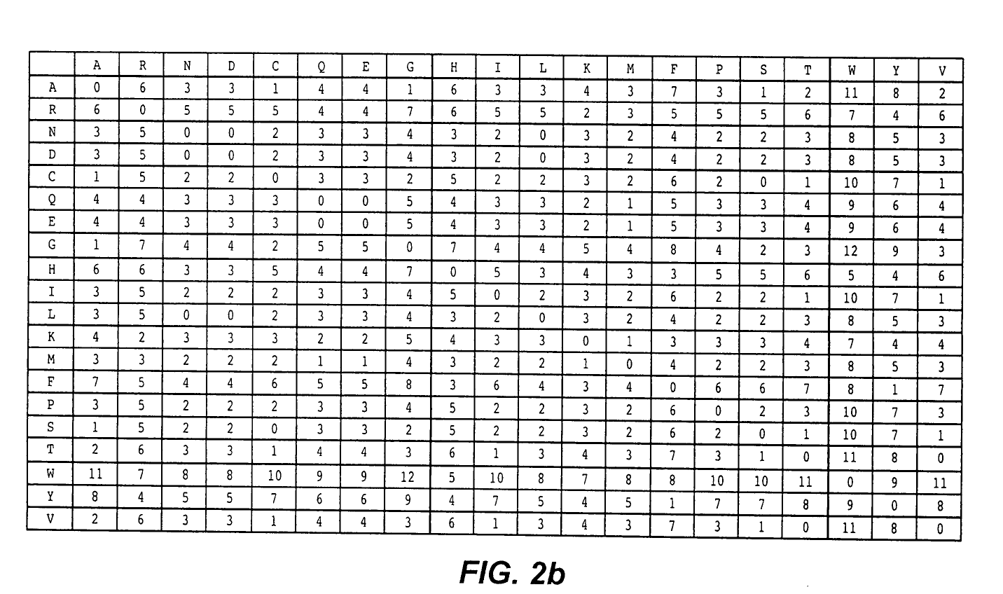

A topological amino acid dissimilarity matrix was generated by counting the total number of side-chain non-hydrogen atoms that need to be added or removed to change one amino acid into another. This number was then scaled by the size of the larger amino acid (including Cα) as in Equation 2. For example, G can be changed to V by adding 3 non-hydrogen atoms: Cβ, Cγ1, and Cγ2, and V has a side-chain size of 3 non-hydrogen atoms; therefore, the dissimilarity of G and V was set equal to ¾=0.75. Switching a bond from single to double was given a value of 0.5. The full matrix is presented in FIG. 2a.

An additional topological amino acid dissimilarity matrix was generated by counting the total number of bonds that need to be broken or formed to change one amino acid into another. For example, G can be changed to V by adding 3 bonds: Cα-Cβ, Cβ-Cγ1, and Cβ-Cγ2; therefore, the dissimilarity of G and V was set equal to 3. The full matrix is presented in FIG. 2b.

### Example 2

### Generation of a Hydrophobicity Amino Acid Dissimilarity Matrix

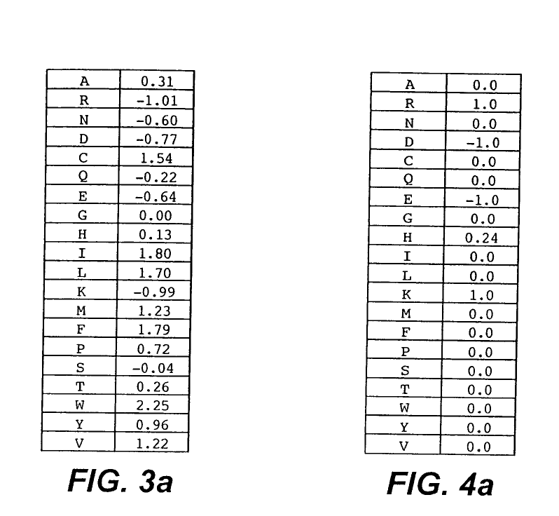

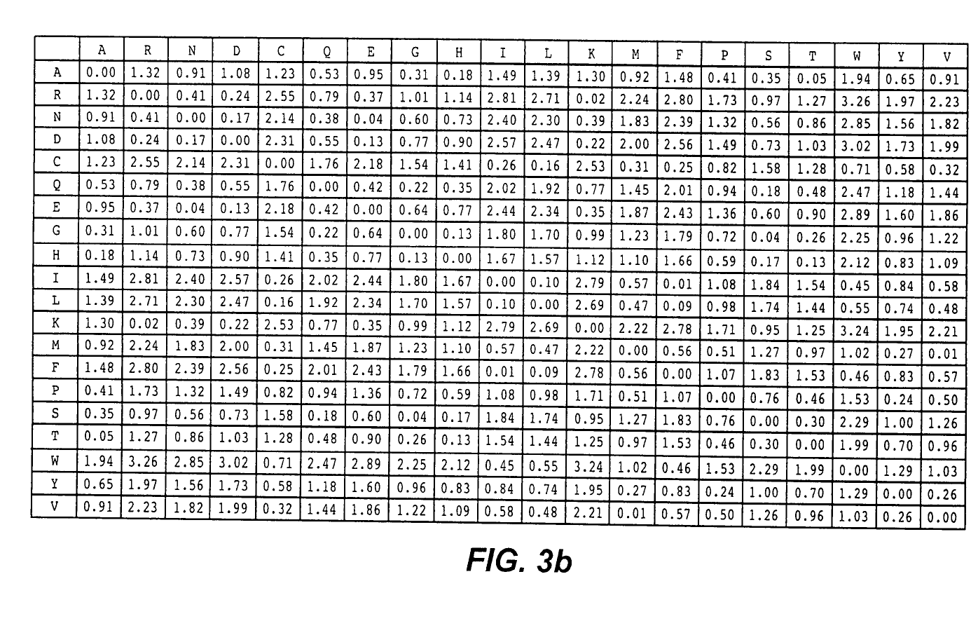

A hydrophobicity dissimilarity matrix was generated using the Fauchere-Pliska amino acid hydrophobicity values (Fauchere & Pliska (1983), J. Eur. J. Med. Chem. 18:369-375, incorporated entirely by reference). Equation 1 was used to transform the hydrophobicity physico-chemical property vector (FIG. 3a) into a dissimilarity matrix. The hydrophobicity dissimilarity matrix is presented in FIG. 3b.

### Example 3

### Generation of a Charge Amino Acid Dissimilarity Matrix

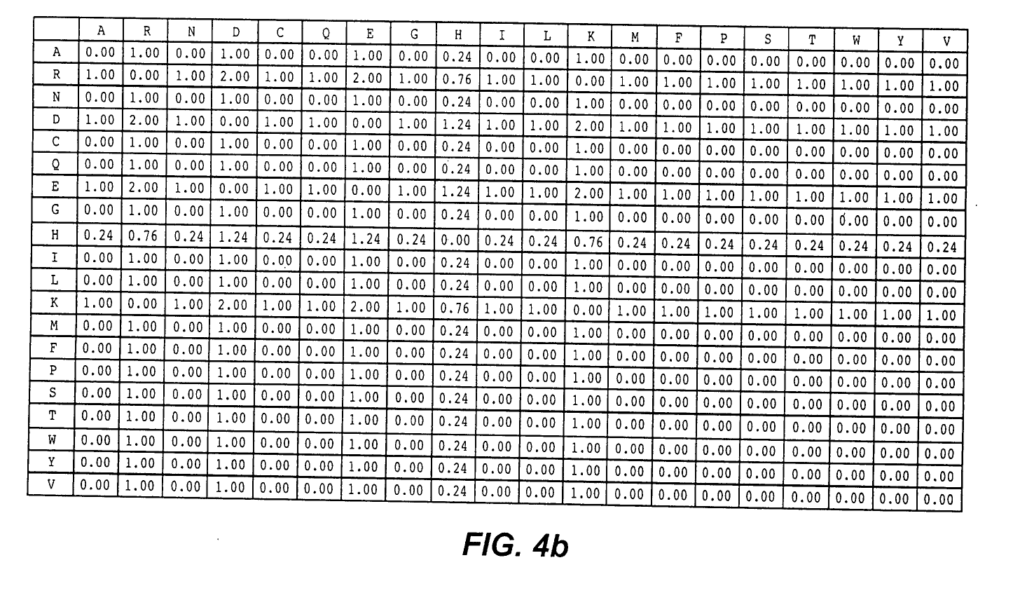

A charge physico-chemical property vector was generated by setting K and R to +1 (positively charged), D and E to −1 (negatively charged), H to +0.24 (slightly positively charged in accordance with its pKa value), and all other amino acids to 0 (neutral). Equation 1 was used to transform the charge physico-chemical property vector (FIG. 4a) into a dissimilarity matrix. The charge dissimilarity matrix is presented in FIG. 4b.

### Example 4

### Generation of a Combined Topological/Hydrophobicity/Charge Amino Acid Dissimilarity Matrix Using Energetic Scaling

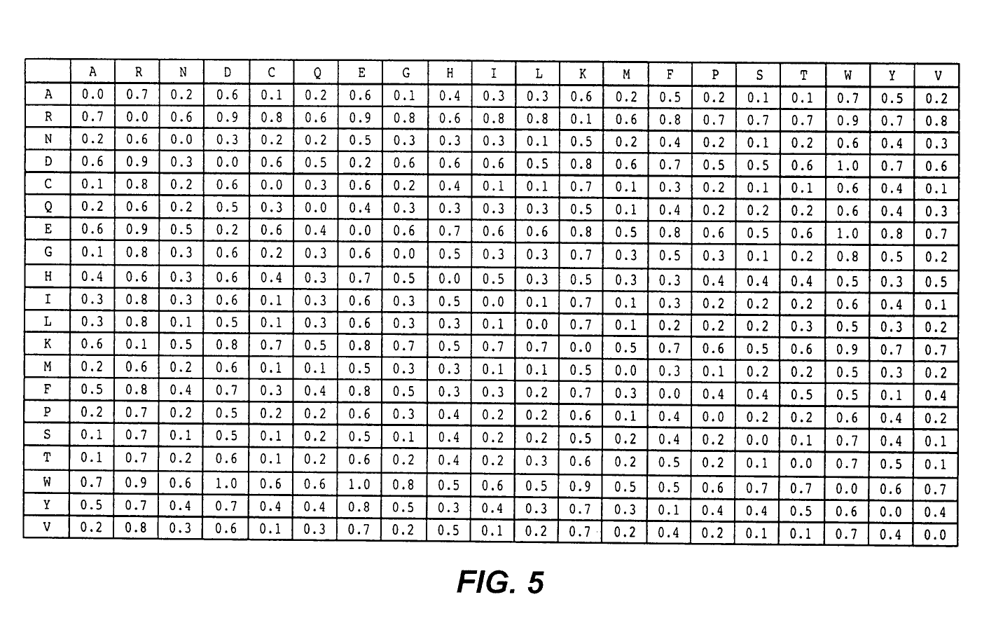

A dissimilarity matrix that includes information from the topological, hydrophobicity, and charge matrices presented in Examples 1-3 was generated using Equation 4. Prior to additive combination, energetic scales were used to give the individual matrices appropriate relative weights. For the topological dissimilarity matrix, a w₍ₜₒₚₒ₎ value of 1.1 kcal/mol per bond broken or formed was used (Kellis et al. (1988), Nature 333:784-786, incorporated entirely by reference). For the hydrophobicity dissimilarity matrix, an W_{(hydr)} value of 1.33 kcal/mol was used to calculate approximate free energy values (van Holde et al. (1998), “Principles of Physical Chemistry”, Prentice Hall, incorporated entirely by reference). For the charge dissimilarity matrix, an W_{(charge)} value of 332·q1·q2/(ε*d)=6.6 kcal/mol was used (q1=q2=1, ε=10, d=5). Note that other ε values can be used when appropriate. These matrices were then combined by addition and finally scaled using Equation 5 (see FIG. 5).

### Example 5

### Generation of a Combined Topological/Hydrophobicity/Charge Amino Acid Dissimilarity Matrix Using the BLOSUM62 Matrix as a Basis

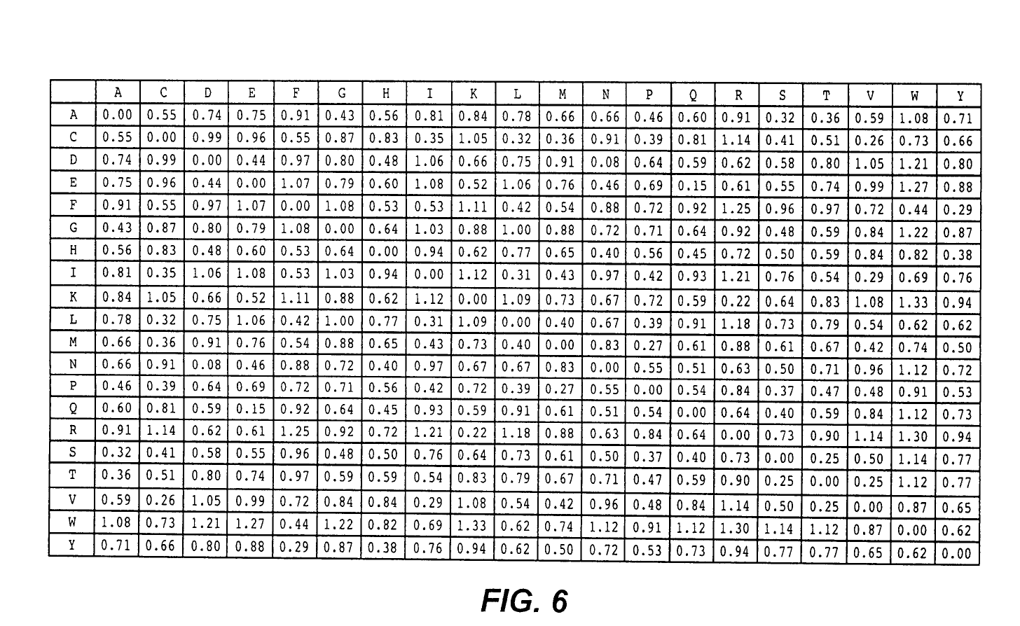

A dissimilarity matrix that includes information from the topological, hydrophobicity, and charge matrices presented in Examples 1-3 was generated using Equation 4. The weights of the three matrices were determined via grid search. The objective of the grid search was to find a dissimilarity matrix with maximum Spearman rank correlation coefficient when compared with the BLOSUM62 substitution matrix. The Spearman correlation coefficient was calculated by comparing the ranks of each amino acid's substitutions with the ranks found in BLOSUM62. The resulting matrix is shown in FIG. 6.

### Example 6

### Designing Libraries with Optimal Coverage

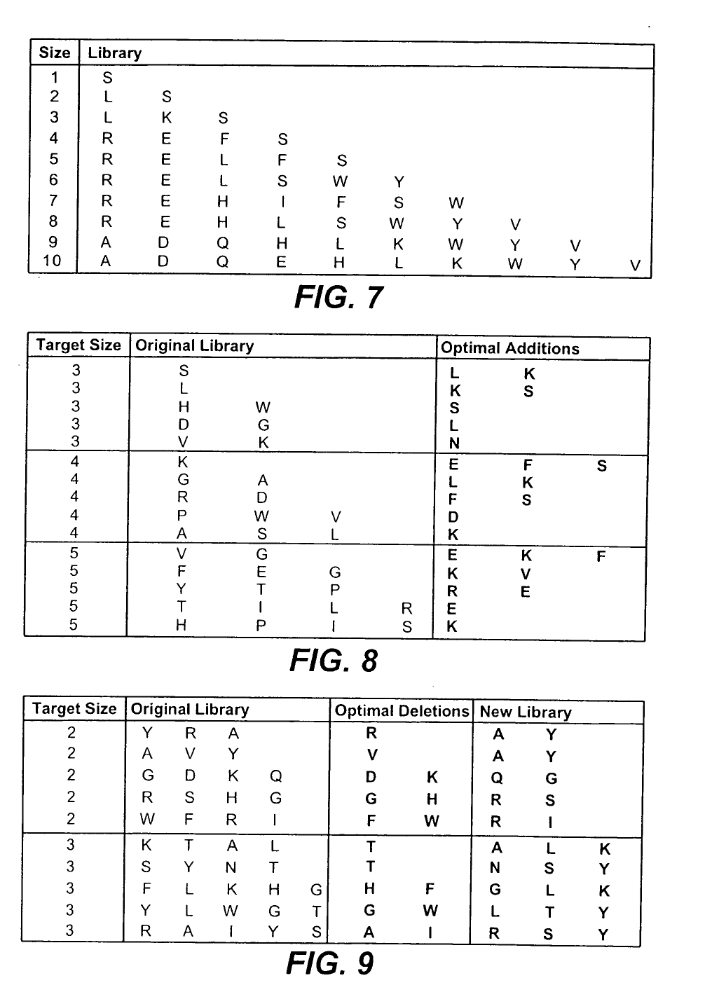

The present invention is used to identify libraries of a specified size with optimal coverage of all natural amino acids except C and M by scoring all possible libraries of that size and reporting the top-ranked library. The combined topological/hydrophobicity/charge amino acid dissimilarity matrix developed in Example 4 was used to identify the optimal naive libraries (fitness index α=0) for sizes of 1 to 10 amino acids using Equations 7, 8, and 10. The resulting libraries are shown in FIG. 7.

### Example 7

### Adding Members to Pre-Existing Libraries to Optimize Coverage

The present invention is used to determine the optimal set of amino acids to add to a preexisting library by scoring all possible libraries of a specified size that contain the preexisting library as a subset. The combined topological/hydrophobicity/charge amino acid dissimilarity matrix developed in Example 4 was used to identify the optimal additions to the preexisting libraries in column 2 of FIG. 8 using Equations 7, 8, and 10 (α=0). The resulting libraries are shown in column 3 of FIG. 8. Note that C and M are excluded from consideration as library members.

### Example 8

### Dropping Members from Existing Libraries while Retaining Coverage

The present invention is used to determine the optimal set of amino acids to drop from a preexisting library by scoring all possible libraries of a specified size that are subsets of the preexisting library. The combined topological/hydrophobicity/charge amino acid dissimilarity matrix developed in Example 4 was used to identify the optimal deletions from the preexisting libraries in column 2 of FIG. 9 using Equations 7, 8, and 10 (α=0). The resulting libraries are shown in column 3 of FIG. 9. Note that C and M are excluded from consideration as library members.

### Example 9

### Grading Libraries for Coverage

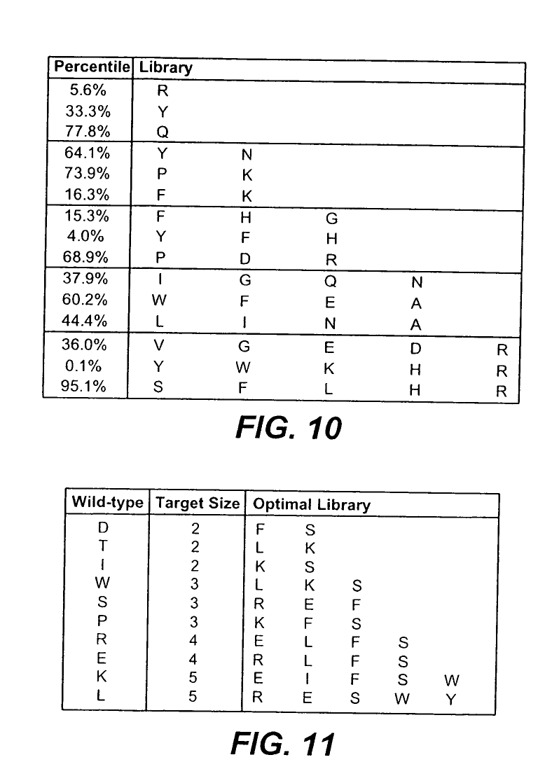

The present invention is used to determine a percentile-based grade for a specified library by scoring it against other possible libraries of the same size. The combined topological/hydrophobicity/charge amino acid dissimilarity matrix developed in Example 4 was used to calculate the percentile of the libraries given in column 2 of FIG. 10 using Equations 7, 8, and 10 (α=0). Percentiles are given in column 1 of FIG. 10. Note that C and M are excluded from consideration as library members.

### Example 10

### Distributing Library Members Around the Wild-Type Amino Acid

The present invention is used to identify libraries designed so that they do not duplicate information contained in the wild-type amino acid. For instance, for a wild-type amino acid of L (hydrophobic), a variant with a V substitution (also hydrophobic) may not carry much additional information. The present invention is used to design non-wild-type-redundant libraries by using the optimal addition run mode (see Example 7) by considering the wild-type amino acid as the preexisting library. The combined topological/hydrophobicity/charge amino acid dissimilarity matrix developed in Example 4 was used to identify the optimal additions to the preexisting wild-type amino acid in column 1 of FIG. 11 using Equations 7, 8, and 10 (α=0). The resulting libraries are given in column 3 of FIG. 11. Note that C and M are excluded from consideration as library members.

### Example 11

### Biasing Libraries Toward the Wild-Type Amino Acid

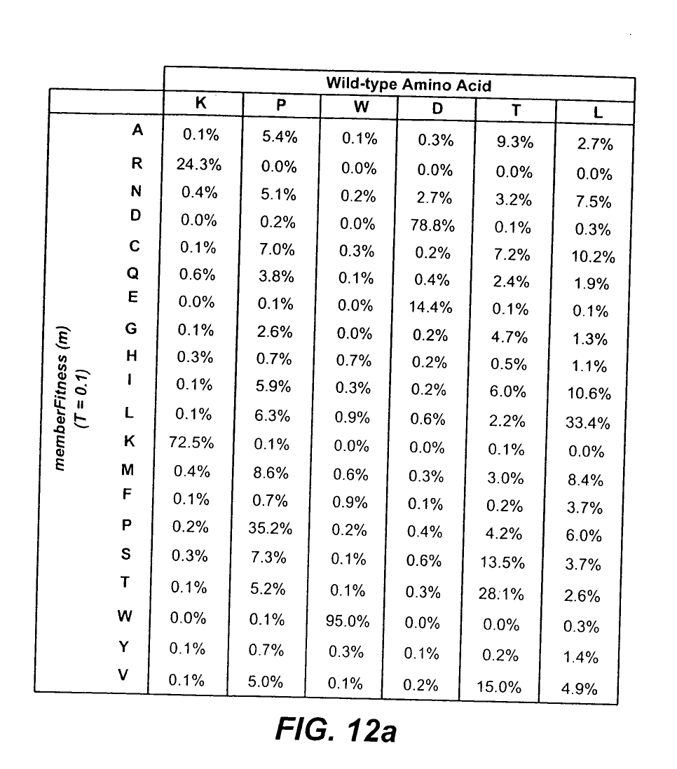

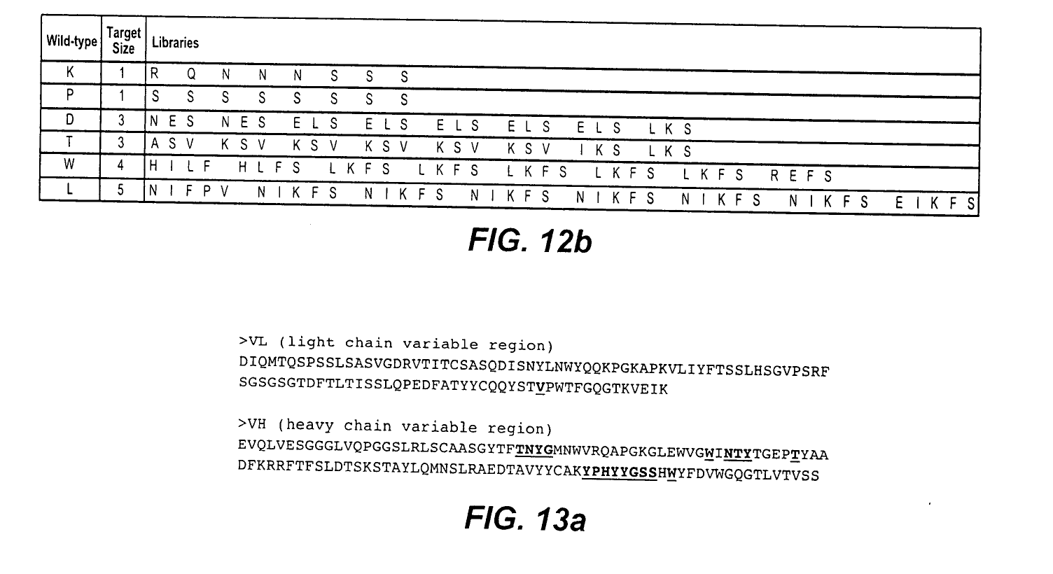

The present invention is used to identify sets of libraries designed with increasing levels of fitness (α proceeding from 0 to 1). Amino acid fitnesses were calculated using the combined topological/hydrophobicity/charge amino acid dissimilarity matrix developed in Example 4 with Equation 13 (see FIG. 12a). Equations 7, 8, 10, and 20 were then used to determine optimal libraries for α=(0, 1/7, 2/7, . . . , 1), and these are listed in FIG. 12b. Note that C and M are excluded from consideration as library members.

### Example 12

### Designing Libraries for Antibody Affinity Optimization

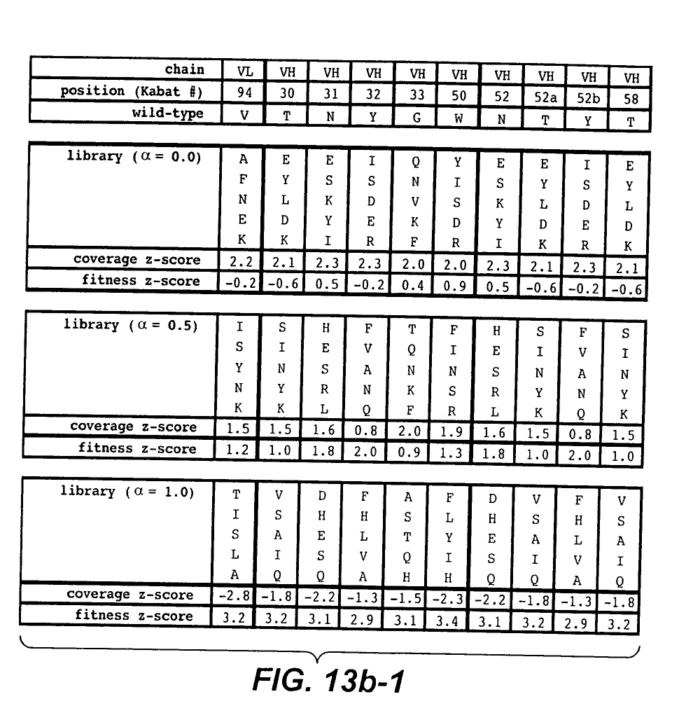

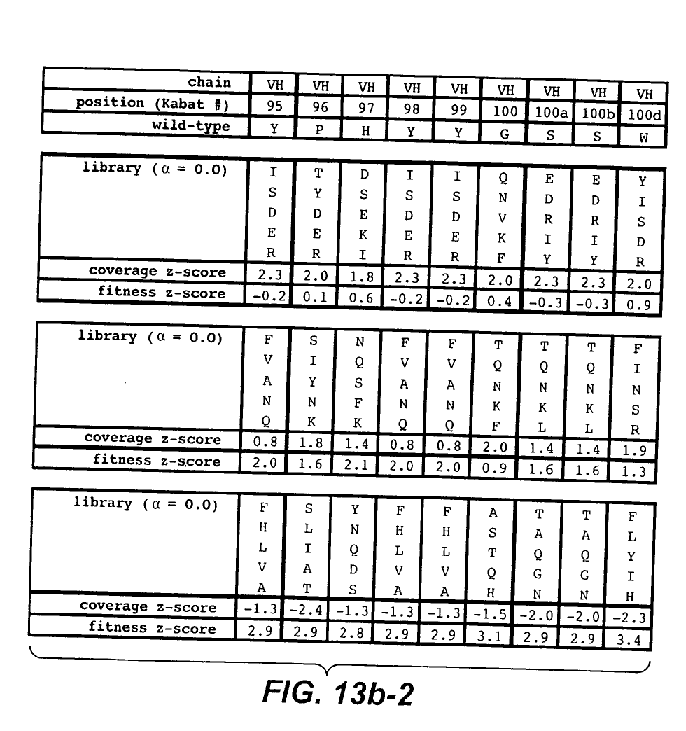

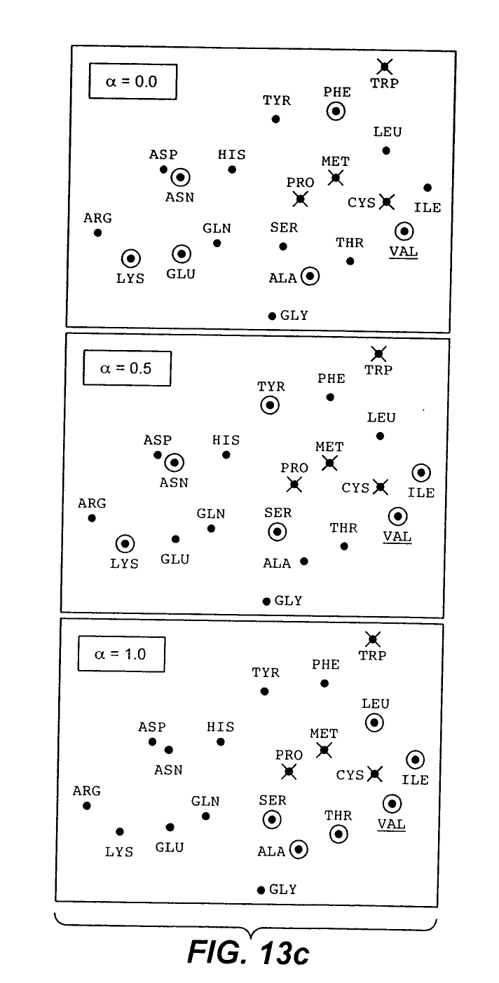

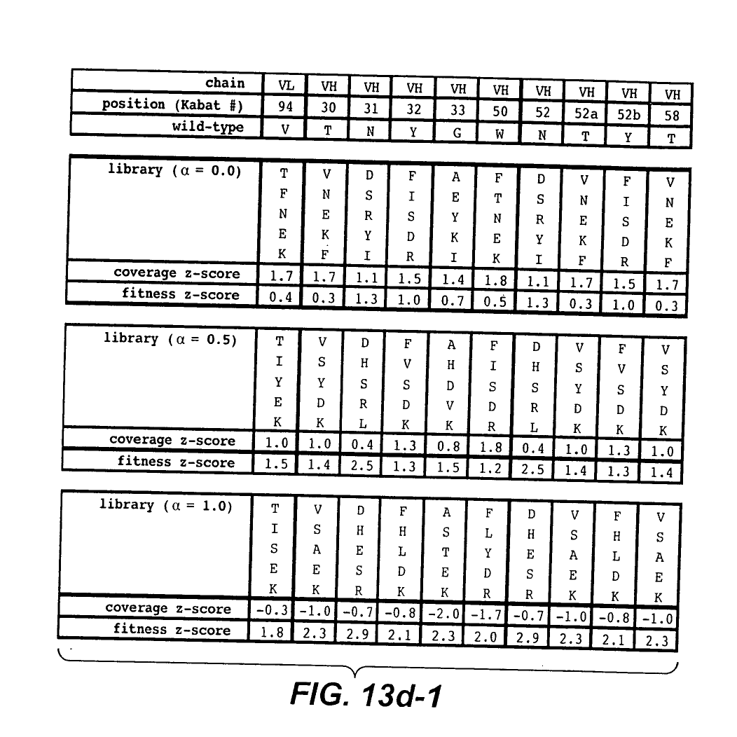

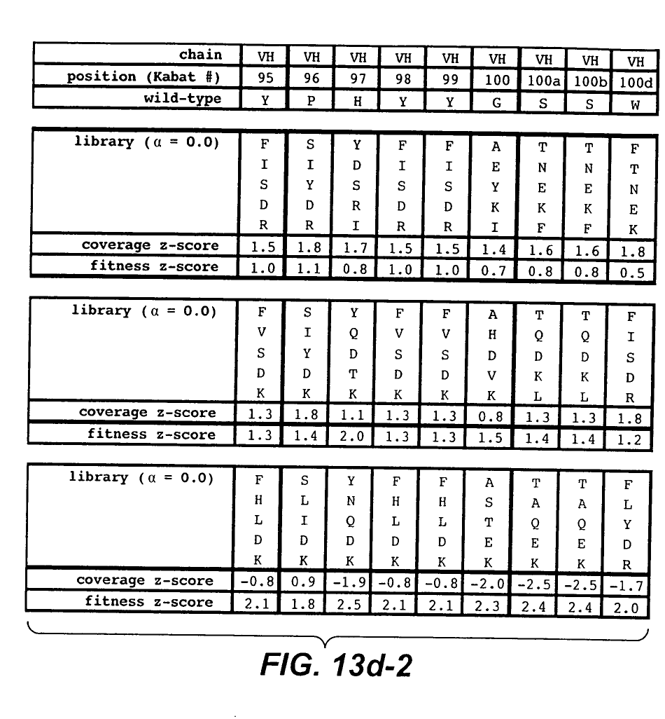

The structure and sequence of an anti-VEGF (Vascular Endothelial Growth Factor) antibody were downloaded (Protein Data Bank code 1 BJ1) to provide an example of how the invention can be utilized to generate libraries for antibody affinity maturation. The set of sequence positions for which libraries were to be designed was determined by identifying sequence positions within 5 Angstroms of the antibody-antigen interface. These positions, found in both the light and heavy chains, are underlined and boldfaced in the amino acid sequences in FIG. 13a (SEQ ID NOS:1-2).

For each position, the invention was used to design three six-member libraries that also include the wild-type amino acid as a member (as in Example 10). The three libraries spanned fitness index values of α=0.0 (high coverage only), 0.5 (both high coverage and fitness), and 1.0 (high fitness only). Equations 6, 8, 10, 11, 13, and 19 were used along with the amino acid dissimilarity matrix developed in Example 5. An alphabet of all natural amino acids excluding cysteine, methionine, proline, and tryptophan was considered. A closer look can be taken at the library designed for the V at position 94 (Kabat numbering) in the light chain. For α=0.0, a library of {A, F, N, E, K} was selected. Note that many amino acid properties are covered by this library, as desired: A=small; F=large, hydrophobic; N=polar; E=negatively charged; K=positively charged. For α=0.5, a library of {I, S, Y, N, K } was selected. Here, more amino acids are selected that are similar to the V wild-type either in hydrophobicity or size {I, S} while still retaining members that cover other amino acid properties {Y, N, K}. For α=1.0, a library of {T, I, S, L, A} was selected. Not surprisingly, without any computational pressure to cover the whole of the amino acid alphabet, the amino acids nearest to V (the most conservative) have been selected. FIG. 13c shows these three libraries compressed onto a 2-D coordinate system that approximates the information contained in the dissimilarity matrix. The libraries for the remaining sequence positions are found in FIG. 13b.

In addition to the libraries found in FIG. 13b, three libraries (α=0.0, 0.5, 1.0) were designed for each position to illustrate the application of compositional constraints. These libraries were constrained to contain (i) the most conservative substitution as determined from the dissimilarity matrix, (ii) at least one negatively charged amino acid {D or E}, and (iii) at least one positively charged amino acid {R or K}. Because of the added constraints, these libraries have reduced alphabet coverage and often reduced fitness. The libraries resulting from this procedure are shown in FIG. 13d.

### Example 13

### Five- and Nine-Member Libraries with High Coverage and Fitness

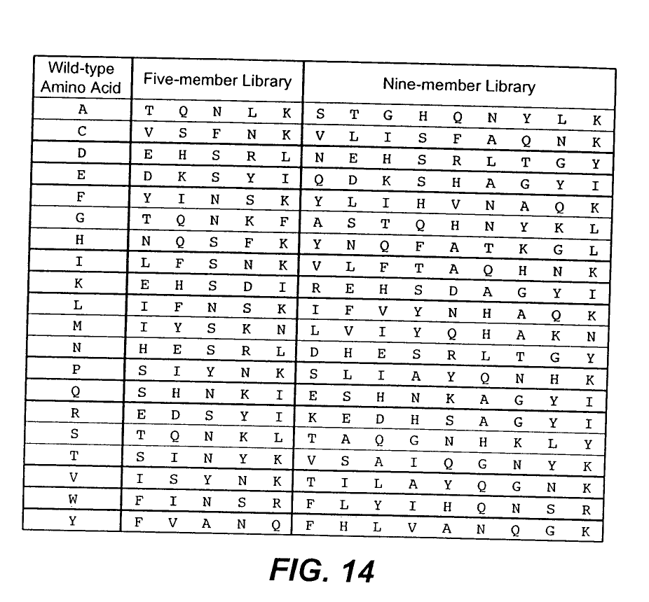

For each of the possible 20 wild-type natural amino acids, the invention was used to design six- and ten-member libraries that also include the wild-type amino acid as a member (as in Example 10). The libraries were determined using a fitness index value of α=0.5 (both high coverage and fitness) along with Equations 6, 8, 10, 11, 13, and 19 and the amino acid dissimilarity matrix developed in Example 5. An alphabet of all natural amino acids excluding cysteine, methionine, proline, and tryptophan was considered. The results are depicted in FIG. 14.

### Example 14

### Designing Libraries for Antibody Affinity Optimization

The structure and sequence of an anti-VEGF (Vascular Endothelial Growth Factor) antibody were downloaded (Protein Data Bank code 1BJ1) to provide an example of how the invention can be utilized to generate libraries for antibody affinity maturation. The set of sequence positions for which libraries were to be designed was determined by identifying sequence positions within 5 Angstroms of the antibody-antigen interface.

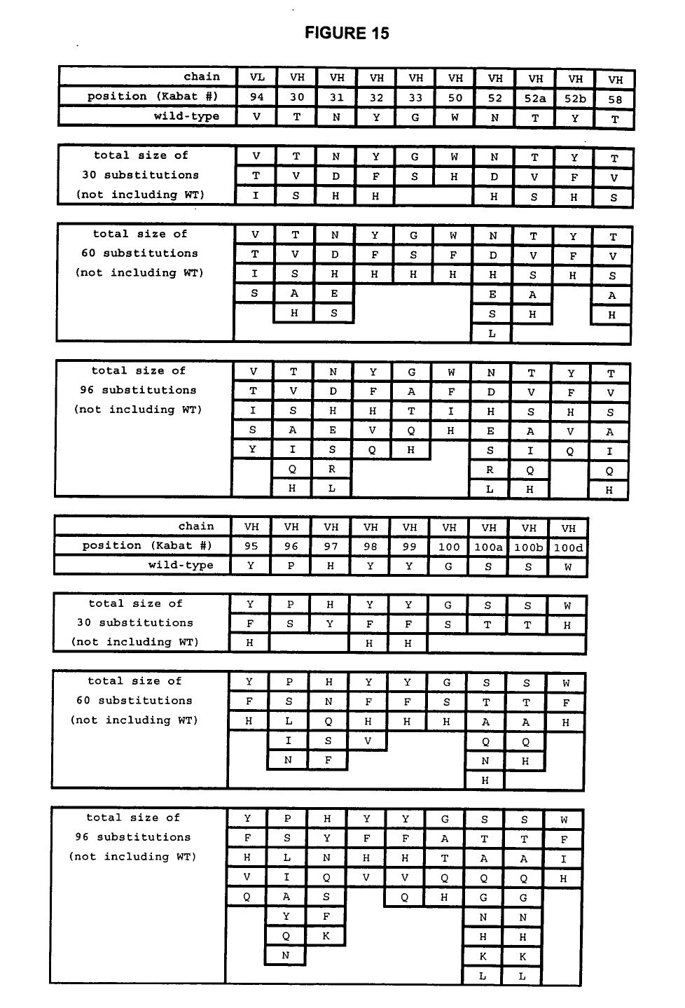

For the set of sequence positions, the invention was used to design three libraries with total sizes of 30, 60 and 96 members (not counting included wild-type amino acids) that also include the wild-type amino acid as a member (as in Example 10). The three libraries were designed using fitness index values of α=0.5 (both high coverage and fitness) and are shown in FIG. 15. Equations 6, 8, 10, 11, 13, and 22 were used along with the amino acid dissimilarity matrix developed in Example 5. An alphabet of all natural amino acids excluding cysteine, methionine, and proline was considered.

We claim:

1. A method of designing a collection of protein variants comprising:
a) inputting a parent protein sequence;
b) identifying P variable amino acid positions in said parent protein sequence, wherein P is two or more;
c) providing a positional alphabet of mᵢ amino acids for each of said variable position;
d) choosing a variant pool size n, where the summation of mᵢ amino acids for all of said variable positions is greater than n;
e) calculating a suitability score for a of a plurality of subsets L of all possible sets of n variant proteins, wherein calculating said suitability score comprises:
i) a fitness score of each said subset L and
ii) a coverage score calculated by applying a dissimilarity matrix to each said subset L; and
f) selecting the subset L having the highest suitability score from said plurality of subsets.

2. The method of claim 1, wherein said inputting step comprises-inputting three dimensional coordinates of said parent protein.

3. The method of claim 1, wherein said plurality of combinations is the total combinations.

4. The method of claim 1, further comprising making said protein variants.

5. The method of claim 1, further comprising testing the activity of said protein variants as compared to said parent protein.

6. The method of claim 1, wherein said alphabet comprises unnatural amino acids.

7. The method of claim 1, wherein calculating said coverage score comprises applying equations 6, 8, and 10.

8. The method of claim 1, wherein calculating said coverage score comprises applying equations 7, 8, and 10.

9. The method of claim 1, wherein calculating said coverage score comprises applying equations 9 and 10.

10. The method of claim 1, wherein selecting said combination comprises the use of compositional constraints.

11. The method of claim 2, wherein said step of calculating said suitability score comprises applying z-scores.

12. The method of claim 2, wherein said standardizing utilizes percentiles.


SEQUENCE LISTING (2 sequences)

SEQ ID NO: 1 - protein, 107 aa, Mus musculus [sequence omitted]

SEQ ID NO: 2 - protein, 123 aa, Mus musculus [sequence omitted]